(19) United States
(12) Patent Application Publication
(10) Pub. No.: US 2014/0018220 A1
(43) Pub. Date: Jan. 16, 2014

(54) METHOD OF PRODUCING A PACKAGE

(71) Applicant: Multivac Sepp Haggenmüller GmbH & Co. KG, Wolfertschwenden (DE)

(72) Inventors: Roland Wilhelm, Bad Gronenbach (DE); Reinhard Ruhland, Bad Gronenbach (DE)

(21) Appl. No.: 13/938,956

(22) Filed: Jul. 10, 2013

(30) Foreign Application Priority Data
Jul. 11, 2012 (EP) 12005121.4

(51) Int. Cl. B31B 17/00

(52) U.S. Cl. CPC B31B 17/00
USPC 493/121

(57) ABSTRACT

The invention relates to a method of producing a reclosable package with a reinforced package edge, the package comprising a bottom film, a cover film and a frame.

### CROSS-REFERENCE TO RELATED APPLICATIONS

This Application claims priority to European Application Number 12005121.4 filed Jul. 11, 2012, to Roland Wilhelm and Reinhard Ruhland entitled “Method of Producing a Package,” currently pending, the entire disclosure of which is incorporated herein by reference.

### FIELD OF THE INVENTION

The invention relates to a method which is used for producing a reclosable package with a reinforced tray edge.

### BACKGROUND OF THE INVENTION

EP 2 070 488 A1 discloses a package for medical devices, which is produced from three webshaped materials. One of these materials is Tyvec®, which is attached to a cutout in the plastic cover film and which, together with a plastic tub, defines a package.

DE 10 2006 017 258 A1, which was filed by the applicant himself, discloses a package and a method of producing a package with a reinforced package edge. The package is here produced on a thermoform packaging machine, and is provided with an angled edge portion so as to provide a mechanically stable edge of the package, so that the package will retain its shape even after evacuation and final sealing with a cover film.

### SUMMARY OF THE INVENTION

It is the object of the present invention to provide a plastic package which should be producible from a soft film on the one hand, and have a stable sealing edge on the other hand, so as to allow reclosing of the package making use of peelable and adhesive films.

The method according to one embodiment of the present invention, which is used for producing a reclosable package including a reinforced package edge and at least three layers of film, comprises the following process steps:
forming a plurality of troughs in a bottom film in a forming station,
supplying a plurality of frames to the bottom film, the number of frames corresponding to the number of troughs formed,
sealing the frames onto the bottom film in a sealing station,
sealing a cover film onto the frames or the bottom film.

Due to the frame sealed onto the bottom film, the area of the package edge and thus the sealing area for the cover film can be reinforced so that an ergonomic and easily handable reclosure possibility can be provided, even when the bottom film is configured as a soft film.

The method according to the present invention can be executed on a packaging machine operating in operation cycles. In this case, it would be imaginable that the plurality of troughs in the lower film are formed either simultaneously in a single operating cycle or successively in a plurality of successive operating cycles. A number of frames corresponding to the number of troughs of the respective operating cycle should in this case be fed to the bottom film in each operating cycle. In other words, either a single trough or a plurality of troughs may be produced in a single operating cycle.

Sealing can take place under a vacuum and/or modified atmosphere and produces a gastight package for packaging, for example, food in a gastight manner thus providing long-time freshness.

According to one embodiment, the frames are unwound from a roll in the form of a webshaped material with openings, and supplied to the sealing station so as to process the frames as a composite film with openings on a thermoform packaging machine.

A punching station of a thermoform packaging machine can produce the frames from a full-area (i.e., continuous), webshaped material, so that the operator of the thermoform packaging machine will more easily be able to stock different film rolls for different frames and to produce, by means of the punching station of the thermoform packaging machine, different frames on the thermoform packaging machine itself during production of the packages. The reinforcement of the edge of the packages can thus easily be varied.

A soft film having a maximum thickness of 200 μm may be used as a bottom film so as to facilitate the removal or accessibility of the packed product.

According to one embodiment, a hard film having a minimum thickness of 300 μm is used as the frame so as to improve the reinforcement of the tray edge or allow the use of a low-priced monofilm.

The frame and the bottom film can be inseparably sealed onto one another, whereby it is guaranteed that, when the package is opened by pulling off the cover film, only the cover film itself will become detached from the bottom film or the frame.

The cover film together with the frames and bottom film may be sealed onto one another in the sealing station, so as to allow a short structural shape of the thermoform packaging machine.

According to an alternative embodiment, the cover film is sealed onto the frames in an additional sealing station so as to increase the performance of the thermoform packaging machine in that the sealing process between the cover film and the frames as well as that between the frames and the bottom film can take place successively, the respective process time being normally shorter than the process time required when the three layers of films are all sealed in common.

According to another embodiment, the frames are sealed onto the lower side of the bottom film so as to impart high mechanical stability to the package edge and simultaneously allow peelable and reclosable opening by removing the cover film from and by reattaching it to the bottom film. It is here imaginable that the frames are placed into the sealing tool lower part automatically, for example, by means of a robot, in the form of individual, non-connected frames prior to sealing in the sealing station, so that they can be sealed onto the lower side of the package edge. This sealing need neither be continuous nor gastight, since it will also suffice when the cover film is sealed onto the bottom film in a gastight manner It is also imaginable to use frames which do not consist of a plastic material but, for example, of a recyclable material exhibiting a good rigidity.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is an exploded top perspective view of a package that can be produced by the method according to one embodiment of the present invention;

FIG. 1a is a top perspective view of the package of FIG. 1 during opening;

FIG. 1b is a bottom perspective view of the package of FIG. 1 after opening;

FIG. 1c is a top perspective view of the package of FIG. 1 during reclosing;

FIG. 2 is a schematic representation of a thermoform packaging machine that can be operated with the method according to one embodiment of the present invention; and

FIG. 3 is a schematic representation of a thermoform packaging machine on which an alternative method according to one embodiment of the present invention can be executed.

Identical components are designated by identical a reference numerals throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

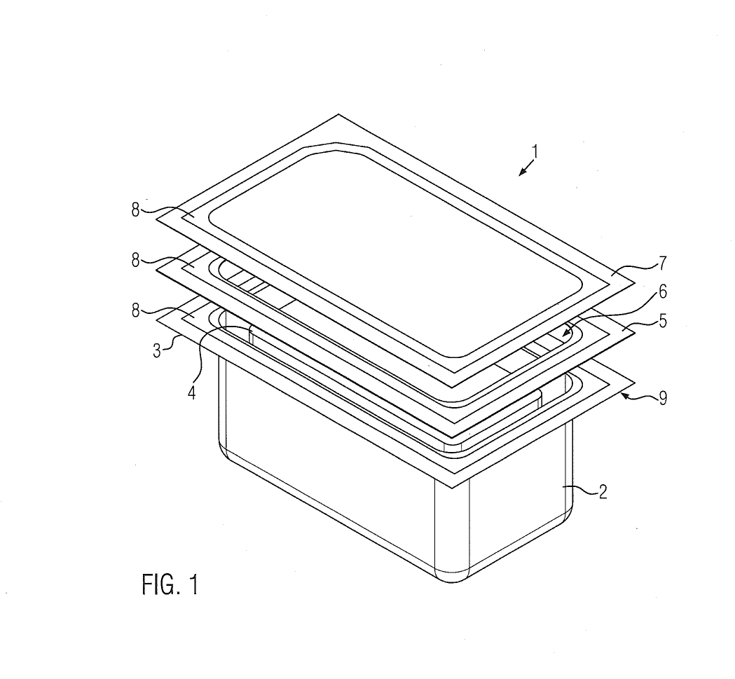

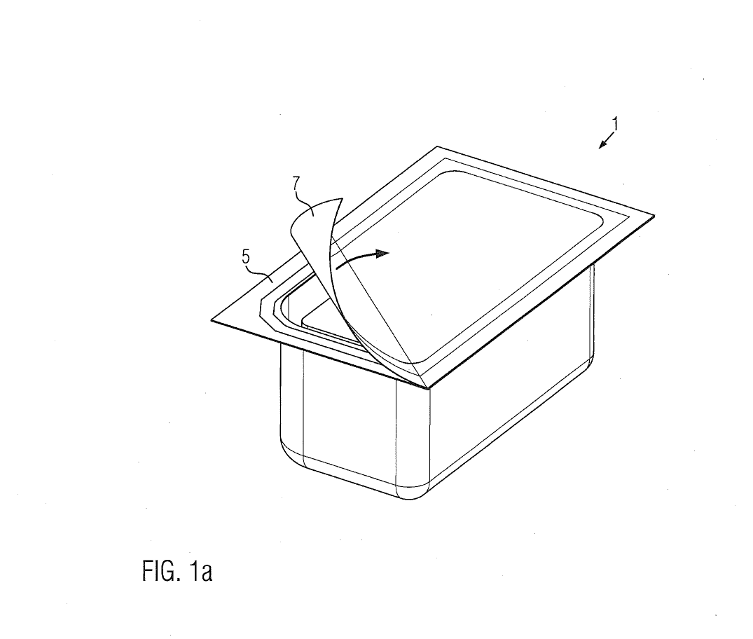

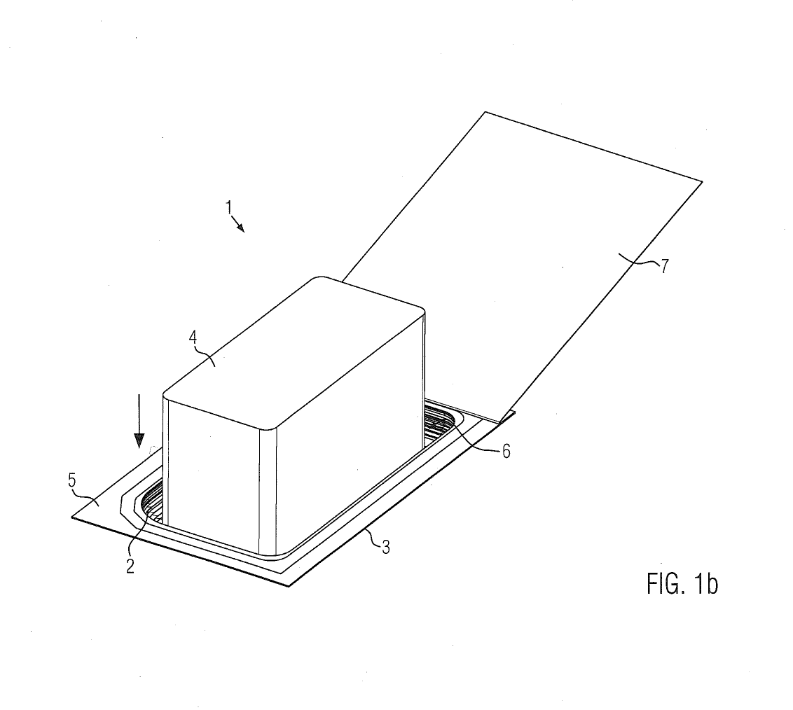

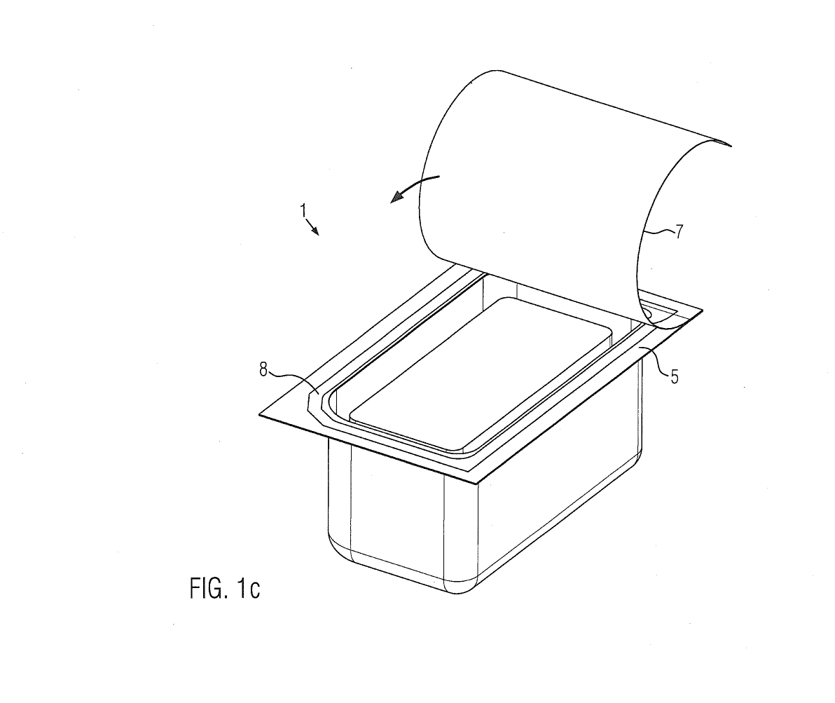

FIG. 1 shows, in an exploded view, a package 1 comprising a bottom film/foil 3 formed into a trough 2 in which a product 4, for example, a cheese block, is packed. The bottom film 3 has disposed thereon a circumferentially extending frame 5 with an opening 6 and, on top of said frame and opening, a cover film 7, said components being sealed to one another in a gastight manner along a sealing seam 8. The bottom film 3 and the cover film 7 can be made of a soft film, whereas the frame 5 can be made of a hard film so as to impart sufficient mechanical stability to the edge 9 of the package.

FIG. 1a shows the package 1 during opening by pulling the cover film 7 off the frame 5. The connection between the cover film 7 and the frame 5 is here peelable, i.e., it can be pulled off, but may also be gastight.

When the cover film 7 has been pulled off the frame 5 to a very large extent, the frame 5 can, due to the largely complementary opening 6 of the frame and of the trough 2 and due to the fact that the bottom film 3 is configured as a soft film, expose product 4 through downward displacement along the product 4, as shown in FIG. 1b. Subsequently, the product 4 can easily be removed or handled. For example, cheese can be removed from a cheese block by means of a scraper.

FIG. 1c shows the package 1 prior to reclosing the cover film 7 with the frame 5, after the frame 5 has been raised. The connection, i.e., the sealing seam 8 between the cover film 7 and the frame 5, is here adhesive so that the cover film 7 can be attached to the frame 5 to prevent the product from drying out, when it is, for example, kept in a refrigerator. This can be accomplished easily and ergonomically by using a hard film for the frame 5 so as to impart the necessary stability to the edge of the package and consequently to the sealing seam 8, so that an approximately planar surface is provided.

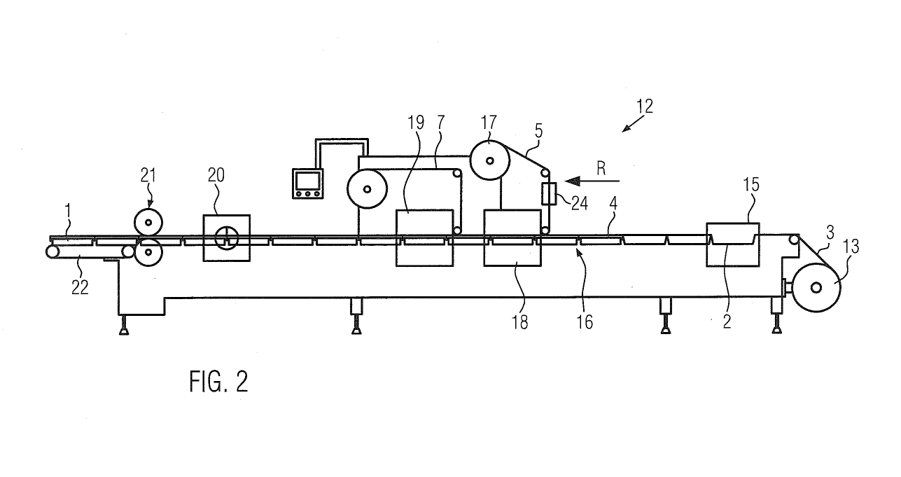

On the thermoform packaging machine 12 shown in FIG. 2, a bottom film 3 is unwound from a film roll 13. In a forming station 15, the bottom film 3 can be thermoformed sectionwise into troughs 2. In a downstream filling station 16 the troughs 2 are filled with a product 4.

Frames 5 are unwound from a film roll 17 and supplied to a sealing station 18. In said sealing station 18, the frames 5 are sealed onto the bottom film 3, each trough 2 of the bottom film 3 having associated therewith a frame 5. The sealing may here be a continuous gastight sealing seam 8 (not shown) or the frame 5 may be fixed to the bottom film 3 only by means of a plurality of sealing points.

In a further sealing station 19 located downstream of said first sealing station 18, when seen in the direction of production R, the cover film 7 is supplied and sealed onto the frame 5 along the sealing seam 8 so as to faun a gastight sealed package 1. Sealing takes place in the manner known under the influence of heat and pressure onto the sealing seam 8.

Downstream of the additional sealing station 19, a cross cutting unit 20 and a longitudinal cutting unit 21 can be provided for separating the product packages 1 from the bottom film composite 3. The singulated packages 1 may be transferred onto a discharge belt 22 on which they are conveyed out of the thermoform packaging machine 12.

Optionally, a punching device 24 may be provided, which is arranged upstream of the sealing station 18, when seen in the direction of production R, for punching openings 6 into a webshaped film web, preferably a hard film, so as to produce frames 5.

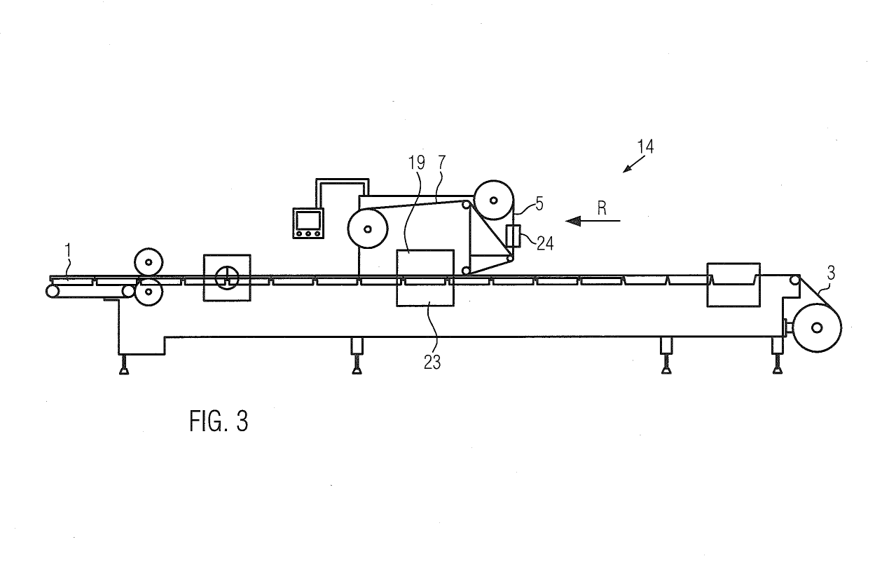

FIG. 3 shows an alternative thermoform packaging machine 14 in which, other than in the case of the thermoform packaging machine 12 according to FIG. 2, the cover film 7 is supplied together with the frames 5 to the sealing station 19 where it is, together with the bottom film 3, subjected to sealing so as to form a gastight package 1. Like in FIG. 2, the frames 5 are configured as a webshaped film material, made preferably of a hard film, in the form of a kind of film grid with openings 6.

Also in the case of the alternative machine 14 according to FIG. 3, a punching device 24 may optionally be provided, which is arranged upstream of the sealing station 18, when seen in the direction of production R, for punching openings 6 into a webshaped film web, preferably a hard film, so as to produce frames 5.

According to an alternative embodiment, individual frames 5 produced, for example, by injection molding are placed into the sealing tool lower part 23 (cf. FIG. 3) by means of robots, which are not shown, and are subjected to sealing together with the bottom film 3 and the cover film 7. According to this embodiment, a supply of frames 5, as shown in FIG. 3, does not take place. The frames 5 are, however, not sealed in position between the bottom film 3 and the cover film 7, but the frames 5 are sealed onto the bottom film 3 from below and the cover film 7 is then sealed onto the bottom film 3.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of producing a reclosable package including a reinforced package edge and at least three layers of film, the method comprising the following process steps:
forming a plurality of troughs in a bottom film in a forming station;
supplying a plurality of frames to the bottom film, the number of frames corresponding to the number of troughs formed;
sealing the frames onto the bottom film in a first sealing station; and
sealing a cover film onto the frames or the bottom film.

2. The method according to claim 1, wherein the sealing of the cover film takes place under a vacuum and/or modified atmosphere and produces a gastight reclosable package.

3. The method according to claim 1, wherein the frames are unwound from a roll in the form of a webshaped material with openings, and supplied to the first sealing station.

4. The method according to claim 1, wherein a punching station of a thermoform packaging machine produces the frames from a full-area, webshaped material.

5. The method according to claim 1, wherein a soft film having a maximum thickness of about 200 μm is used as a material for the bottom film.

6. The method according to claim 1, wherein a hard film having a minimum thickness of about 300 μm is used as a material for the frame.

7. The method according to claim 1, wherein the frames and the bottom film are inseparably sealed to one another.

8. The method according to claim 1, wherein, in the first sealing station, the cover film together with the frames and the bottom film are sealed onto one another.

9. The method according to claim 1, wherein the cover film is sealed onto the frames in a second sealing station, after the frames and the bottom film have previously been sealed onto one another in the first sealing station.

10. The method according to claim 1, wherein the frames are sealed onto a lower side of the bottom film.
